(19) United States
(12) Patent Application Publication
(10) Pub. No.: US 2003/0065504 A1
(43) Pub. Date: Apr. 3, 2003

(54) Instant verbal translator

(76) Inventors: Jessica Kraemer, Monument, CO (US); Lee Macklin, Colorado Springs, CO (US)

Correspondence Address: HEWLETT-PACKARD COMPANY, Intellectual Property Administration, P.O. Box 272400, Fort Collins, CO, 80527-2400, US

(21) Appl. No.: 09/968,385

(22) Filed: Oct. 2, 2001

(51) Int. Cl. G06F 17/20

(52) U.S. Cl. 704/8

(57) ABSTRACT

A system and process for providing instant translations of verbal communications is provided. The present invention provides mobile translation capabilities to any Person at any location. In one embodiment, the system utilizes a first device and a second device, each device being utilized by a Person to communicate and receive translated verbal communications. Each device includes an input device for receiving a verbal communication, a database containing software and algorithms utilized to translate the verbal communication from a first language into a second language, a processor for implementing the software, an output device for presenting a translated verbal communication to a Person and a communications link for transmitting verbal communications from one Person's device to a second Person's device for translation and presentation to the other Person. Additional embodiments are provided in which a single processor device is connected to a remote receiving device or a second output device.

### TECHNICAL FIELD

The present invention relates generally to the translation of verbal communications by mobile translating devices. More specifically, the present invention provides a system and method for automatically translating verbal communications received in a first language into a second language such that two persons may directly communicate.

### BACKGROUND

As is commonly appreciated, verbal (as compared with written) communications are the predominant mode of communication between two or more Persons. For purposes of simplicity, throughout this application a “Person” shall be construed to include both an originator of verbal communications and a recipient thereof regardless of whether the communications are generated or received by a human or another source including, but not limited to, artificial sources (such as communications generated/synthesized by computers or similar devices and/or communications received and/or interpreted by computerized voice recognition and verification systems). Further, regardless of the origin and/or the intended recipient, verbal communications enable the speaker and the recipient to quickly and efficiently communicate information, ideas and intentions, provided that both Persons are fluent (or at least conversant) in the same language.

With the advent of modern air travel, the Internet, worldwide telephone services, and the global economy, the opportunity and need for Persons who are fluent in different languages to communicate verbally has increased tremendously. While various systems and processes have been developed for translating and communicating written information between Persons fluent in different languages, systems are needed which enable Persons to verbally communicate in their native languages with each other without the need of human interpreters and/or multiple language proficiencies. Further, since Persons are often mobile, traveling to foreign countries, and communicate directly, in person, with others who may not be fluent in the same languages, there is a further need for verbal language translation systems and processes which are mobile and do not require access to and/or connection with centralized devices and/or translators.

While various systems have been recently proposed which provide verbal translations to Persons in different locations (for example, AT&T's® international calling language translation services), it is believed that such systems and processes require Persons to utilize networked communication systems which utilize centralized servers, regional servers or similarly situated servers and/or computers to provide the desired verbal translation services. Further, such systems require both Persons to be connected via a telephone circuit in order for the translations to occur. As is commonly appreciated, it is not possible nor feasible to equip every person with a wireless or wired telephone in order to facilitate translations of communications between multiple Persons. Thus, current telephone based systems are inadequate for addressing the need for systems and processes providing instant verbal translation capabilities. Additionally, various other devices, systems and processes which do not depend upon or utilize telephone systems have been proposed for providing mobile verbal translation capabilities. One example of such a system is the Via II, which utilizes a wearable microprocessor, a speaker, and a microphone input to provide limited language translation capabilities. While such a device overcomes the limitations of telephone and server based implementations and provides some portability needed in an instant verbal translator, such system, however, does not provide reliable and efficient verbal translations because the input and output devices may be subject to interference, background noise and even translations of translated communications (i.e., the translator ends up translating the information it previously received and translated, thereby possibly becoming stuck in an endless loop). Further, the Via II system does not include or provide a system and process which enables each Person to speak and hear communications in a preferred language without having to hear part or all of the original communication or translation of communications in a language utilized by a second Person.

As such, a system and process is needed which enables a first Person to speak and hear communications in a first language while a second Person also speaks and hears the communications in a second language. Such a system and process desirably would not be subjected to interference from the translations and/or communications of each Person while providing a mobile, easy to use and operate system that is not dependent upon telephone circuits and/or centralized servers for its use.

### SUMMARY

The present invention provides a mobile system and process for receiving verbal communications in a first language from a first Person, instantly translating the received communications and presenting the translation verbally in a second language to a second Person. The communications may be verbally presented by any Person in any language and translated into any second language for which translation between the first and second language are possible. It is to be appreciated, that translations between certain languages may not be possible for all or even a portion of a given language. As such, the present invention translates those words and/or phrases for which translations are possible.

Further, the systems of the present invention may be configured to receive and translate verbal communications from any Person. As such, synthetically generated (for example, those generated by a computer synthesized voice module), pre-recorded or other non-live and non-face-to-face verbal communications may be translated by the system as well as face-to-face spoken communications between human beings. As is commonly appreciated, synthetically generated communications are often encountered when dealing with automated systems (for example, when attempting to call an airline or make a long distance call). Similarly, pre-recorded communications are often encountered in public areas (for example, announcements of upcoming flights in an airport, announcements of train arrivals in a subway, and/or directions from a tour guide). As such, the present invention is agnostic as far as the origin of the communications and may be configured, as shown in the various embodiments, to process verbal communications from multiple types and/or simultaneous sources.

In one embodiment, the present invention utilizes two translating devices that communicate with each other over a wireless connection. Each device includes a processor, a database, a communications link interface (including an antenna), an input device (e.g., a microphone), an output device (e.g., an ear piece/headphone/speaker), which provides translated verbal communications to each Person.

In a second embodiment, the present invention utilizes a first translating device that includes a processor, a database, an input device (e.g., a microphone), an output device (e.g., a earpiece or headphone), and a wired or wireless communications link. The wireless communications link is connected to a second device used by another Person. This second device includes a receiver (for receiving the communications from the first translating device), and an output device (e.g., a headphone or speaker). In this embodiment, the first Person and second Person provide verbal communications to the device via the microphone. The processor then translates the received communications into the desired language(s) and sends a translated message to either the first output device or the second output device, depending upon the intended recipient of the translated communications.

In a third embodiment, the present invention utilizes a single device which includes a processor, a database, an input device (e.g., a microphone) and two output devices (e.g., earpieces, headsets or speakers which are utilized to provide the translated communications to the intended Person. This embodiment preferably does not utilize wireless communications links to connect to a device utilized by a second Person and instead provides all the needed functionality in a single device.

As such, the present invention provides various embodiments of mobile systems and processes which provide instant verbal translation capabilities to multiple Persons.

### DESCRIPTION OF THE DRAWINGS

FIG. 1 is a schematic representation of a system utilizing two translating devices for providing instant translations of verbal communications for one embodiment of the present invention;

FIG. 2 is a schematic representation of a system utilizing a master and a slave translating device for providing instant translations of verbal communications for a second embodiment of the present invention;

FIG. 3 is a schematic representation of a system utilizing a single translating device with multiple input and output devices for providing instant translations of verbal communications for a third embodiment of the present invention;

FIG. 4 is a schematic representation of the system of FIG. 1 wherein a remote database, accessed via a network server, is utilized to provide instant translations of verbal communications for another embodiment of the present invention; and

FIG. 5 is a flow diagram illustrating one process flow for instantly translating verbal communications for an embodiment of the present invention.

### DETAILED DESCRIPTION

The present invention provides a system and process for providing instant translations of verbal communications between at least two Persons. As shown in the various embodiments specified herein and discussed in greater detail hereinbelow, the system utilizes at least one processor to translate verbal communications received over a first input device and provided to a first Person, in the Person's preferred language, via a first output device while also providing communications that have been translated and are output to a second Person via a second output device. By utilizing two output devices, the present invention reduces and, in certain embodiments, eliminates concerns with feedback and cross-talk that may occur when only a single output device is utilized.

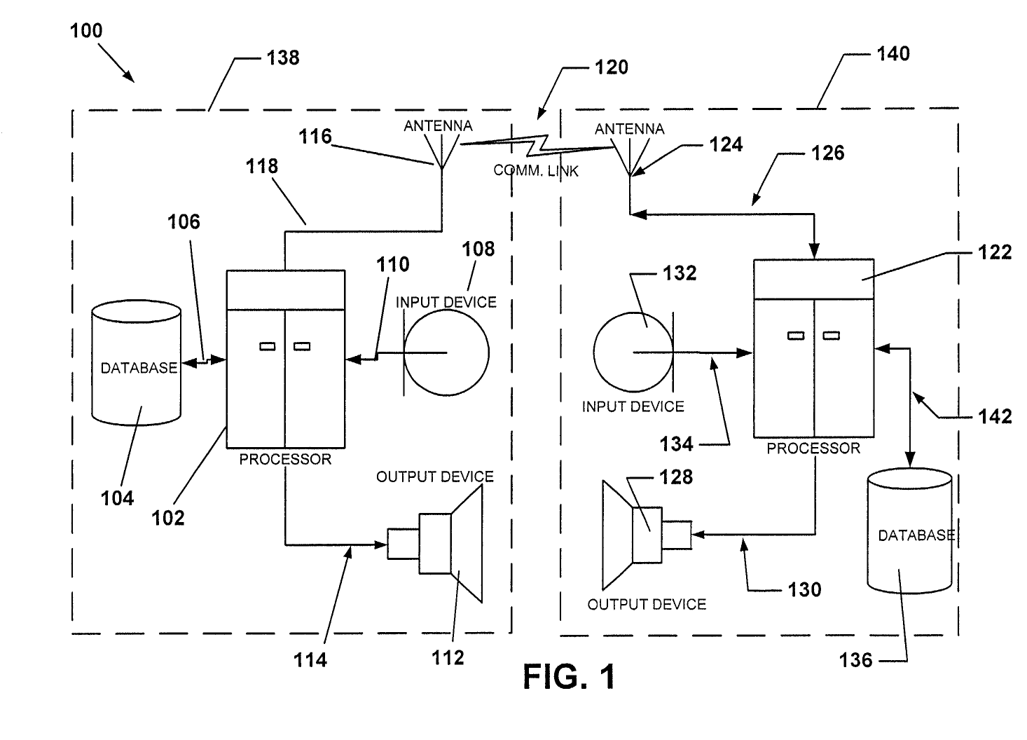

As shown in FIG. 1, for one embodiment of the present invention, a system 100 is provided which includes at least two devices 138/140, one device for each person for whom verbal translations are being provided. Each device respectively includes a processor 102/122, a database 104/136, an input device 108/132 (for example, a microphone), an output device 112/128 (for example, a speaker, an earpiece or a headset), and a communications interface 116/124 (which is illustrated in FIG. 1 as an antenna but includes those signal processors, amplifiers, filters and other devices needed to establish wireless communications with a second device).

The processor 102/122 in one embodiment is a single purpose device that is configured for efficiently and expeditiously translating verbal communications. However, other general purpose processors (for example, those manufactured by INTEL®, AMD®, IBM®, APPLE®, and other processors) may be utilized. The processor 102/122 and the associated processing capabilities may also be provided in other devices including, but not limited to, Personal Data Assistants (PDA), lap top computers, wireless communication devices, hearing aids, sunglasses or other visors that are equipped with audio capabilities, portable music devices (such as portable compact disc players and MP3 players), and similar devices. In short, the processor 102/122 may be provided in any device that is capable of supporting a microprocessor and associated interfaces.

In addition to utilizing a processor that is small, power efficient, portable, and provides the processing capabilities necessary to instantly translate verbal communications, each of the devices 138/140 also include a database 104/136. The database 104/136 may be accomplished using any known technologies including CDROM, DVD, floppy discs, magnetic tape, RAM, ROM, EPROM, memory sticks, flash cards, and other memory/data storage devices. The database 104/136 may be removable or permanent, as desired for specific implementations of the invention. The database 104/136 includes those instructions, program routines, and/or information needed by the processor 102/122 in order to receive, recognize and translate verbal communications from a first language to a second language.

Further, while the embodiment depicted in FIG. 1 shows only a single database 104/136 for each device 138/140, it is to be appreciated that multiple databases and/or partitionable databases may be utilized. For example, one embodiment may include a first database (that may be fixed or may be removable, for example, on a removable memory card) which includes the information necessary for the processor 102/122 to output audible signals in a first language, such as English. Another embodiment may include a second database (that may also be fixed or removable) which includes information necessary to recognize, interpret and translate verbal communications received in a second language (for example, in French). Additional databases may also be provided for translating additional languages or the databases may be substituted for each other as necessary. For example, an English speaking American tourist might utilize a device 138/140 which utilizes an English language database 104/136 to provide translations of non-English verbal communications. While the tourist is in Paris, such translations may be provided by a second database 104/136 configured to recognize, interpret and translate Parisian French. Similarly, as the tourist travels to Hanover, Germany, a third database (which may be inserted or programmed into the device) may be utilized to recognize, interpret and translate Northern German dialects, while a fourth database may be utilized to translate Bavarian dialects.

As such, the database 104/136 provides the information necessary for the processor 102/122 to translate any received verbal communications into a desired language. The present invention may be utilized for any combination of languages for which translating techniques and methodologies are known. Such techniques and methodologies utilized in translating a first language to a second language, however, are beyond the scope of the present invention. The present invention is not limited to any specific technique and may utilize any technique known in the art or hereafter discovered, provided such translating technique can be implemented via a processor 102/122. Examples of known translating techniques include natural language processing techniques, language parsing techniques, syntactic analyses, and other processes. U.S. Pat. No. 6,266,642, issued on Jul. 24, 2001 to Alexander M. Franz and titled “Method and Portable Apparatus for Performing Spoken Language Translation”, the contents of which in their entirety are incorporated herein by reference, provides a discussion of various techniques for performing verbal translations, any of which or others may be utilized by the processor of the present invention to perform the beforementioned instant verbal translations. The rules, processes, algorithms, codes, and other information utilized by such techniques are suitably stored in the database 104/136 and implemented by the processor 102/122.

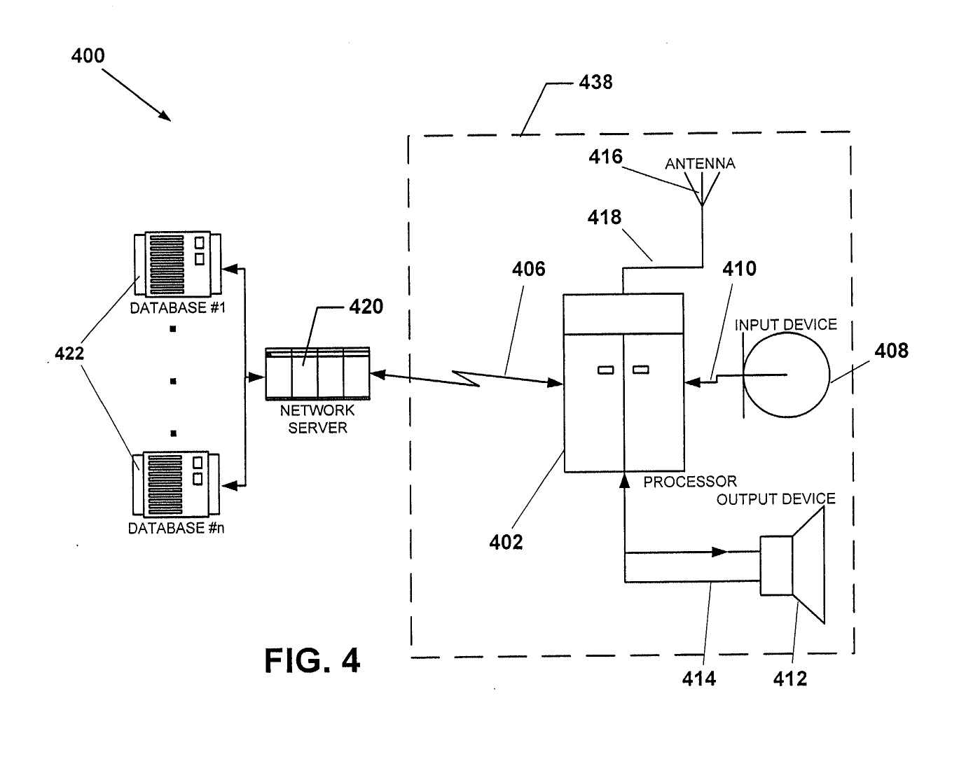

As shown in FIG. 1, a communications link 106/142 connects the processor 102/122 with the database 104/136. In the embodiment shown in FIG. 1, the database 104/136 is co-located with the processor 102/122. However, it is to be appreciated that a wired or wireless communications link may also be utilized to connect the processor 102/122 with the database 104/136. As such, it is to be appreciated that the database 104/136 may also be located proximate to the processor 102/122, for example, provided on a unit affixed to one's belt or elsewhere on a person's body, purse, or proximity. Similarly, the database 104/136 may be located at a remote distance from the processor, for example, provided via a centralized or regional server with which a connection may be established via a wired or wireless communications link. FIG. 4 illustrates one embodiment of a remote database and a wired or wireless communications link 406 connecting the processor 402 with a plurality of databases 422 via a network server 420 (which may or may not be Internet accessible). In such an embodiment, it is to be appreciated that frequent downloads of information to the processor (and associated RAM) may be necessary in order to efficiently and expeditiously translate verbal communications.

Further, combinations of remote and local/proximate database systems may also be utilized. In such an embodiment, the local/proximate database receives updated information from the centralized and/or regional databases as needed. For example, the local database may include enough storage space to hold the information necessary to provide translations for a limited number of languages at any one time. The languages stored in the local database may be substituted with another language upon establishing a wired or wireless connection with a centralized/regional database and downloading the desired language while deleting an undesired language. Thus, the database 102/136 (FIG. 1) may be connected, proximate or remote to the processor with those skilled in the art appreciating that reductions in system processing capabilities may occur with establishing and exchanging information to/from proximate and/or remote databases.

Referring again to FIG. 1, for this embodiment, each device 138/140 also includes an input device 108/132. As shown, the input device 108/132 may be a microphone that captures audible communications. In most applications of the present invention, it is anticipated that audible sound waves (for example, spoken speech) will be received by the input device 108/132 and translated into a specified language for each Person as necessary. However, other input devices may also be utilized including devices that receive audible communications directly from a person's voice box or audible communications transmitted via other mediums including, but not limited to, mediums within the electromagnetic spectrum.

More specifically, in certain embodiments the input device may also be configured to receive verbal communications that are not transmitted via audible sound waves. Examples of such verbal communications include radio station transmissions, public address transmissions, and other forms of communication wherein the verbal information is communicated to a listener via a radio wave, electromagnetic wave, or other medium. The device 138/140 suitably receives such transmissions and translates the verbal messages contained therein into the listener's desired language. For example, the American tourist in Paris may need to receive translations of boarding instructions for an airplane flight at Charles de Gaulle airport. Instead of communicating the instructions repeatedly in multiple languages over the public address system, the airport authorities may communicate the instructions once in French while providing a radio frequency broadcast of the same message which is received by the device 138/140 and translated by the device into the recipient's preferred language. As such, various forms of input devices may be utilized to receive verbal (as compared with textual) communications which are then translated by a processor 102/122 in a given user's device 138/140.

Further, in the embodiment shown in FIG. 1, the input device 138/140 is preferably configured such that each Person's verbal communications are directly received by the microphone 108/128 and then communicated by the processor and a communications link 120 (which is described in greater detail hereinbelow) to a second device for translation by the second user's processor. It is anticipated that by configuring the input device 138/140 such that local verbal communications are received by the input device, concerns with cross-talk, feedback, and other noise may be reduced and/or eliminated, thereby improving the accuracy and efficiency of the translations. However, the input device 108/132 may also be configured to pick-up external communications, as desired, thereby enabling a user of the device 138/140 to receive communications from Persons that are not equipped with the device 138/140. However, in the preferred implementation of this embodiment, each Person engaged in a conversation for which language translations are needed is equipped with the device 138/140.

As shown, the input device 108/132 is suitably connected via a communications link 110/134 with the processor 102/122. As was discussed above in relation to the connections between the processor 102/122 and the database 104/136, the communications link 110/134 between the input device 108/132 and the processor 102/122 may be wired or wireless. Further, the input device 108/132 may be co-located with the processor 102/122 or may be proximate to the processor 102/122.

Referring again to FIG. 1, the device 138/140, for this embodiment, also includes an output device 112/128. The output device 112/128 provides an audible signal to a Person of a received translated communication. The output device 112/128 may be provided in a speaker, an earpiece (for example, one configured as a hearing aid), a headset, or a similar audible output device.

In the preferred implementation of this embodiment a hearing aid configured earpiece is utilized as the output device 112/128, thereby reducing the amount of additional audible signals a person using the device 138/140 may be subjected to as a translation is occurring. In short, the hearing aid earpiece approach seeks to avoid the situation where the user hears and has to filter out both the foreign language and the translation thereof. Instead, the hearing aid earpiece device receives the foreign language and instead of merely amplifying the received sound, it first translates the audible message and provides a translated output to the user of the device. However, other embodiments of the output device may be utilized, including a small headset speaker located proximate to a user's ear. Similarly, but less desirably, a broadcast speaker, discernable by persons proximate to the user, may also be utilized.

Further, the output device 112/128 is also connected via a communications link 114/130 to the processor. As provided before for the various other communications links, this communications link 114/130 may be wired or wireless. However, in the preferred implementation of this embodiment of the present invention, the output device 112/128 and processor 102/122 are preferably co-located and are hard wire connected to each other, for example, in a headset or a hearing aid configured earpiece.

Additionally, each device includes a communications interface 116/124 that facilitates the communication of received verbal communications from a first device to a second device over a communications medium/link 120. The communications interface 116/124 include those components, which are well known in the art, that are utilized in order to communicate information from a first device to a second device, and vice versa. Thus, depending upon the communications medium/link 120 utilized, the communications interface 116/124 provides those filters, receivers, demodulators, modulators, transmitters, and other components necessary to facilitate communications between devices 138/140.

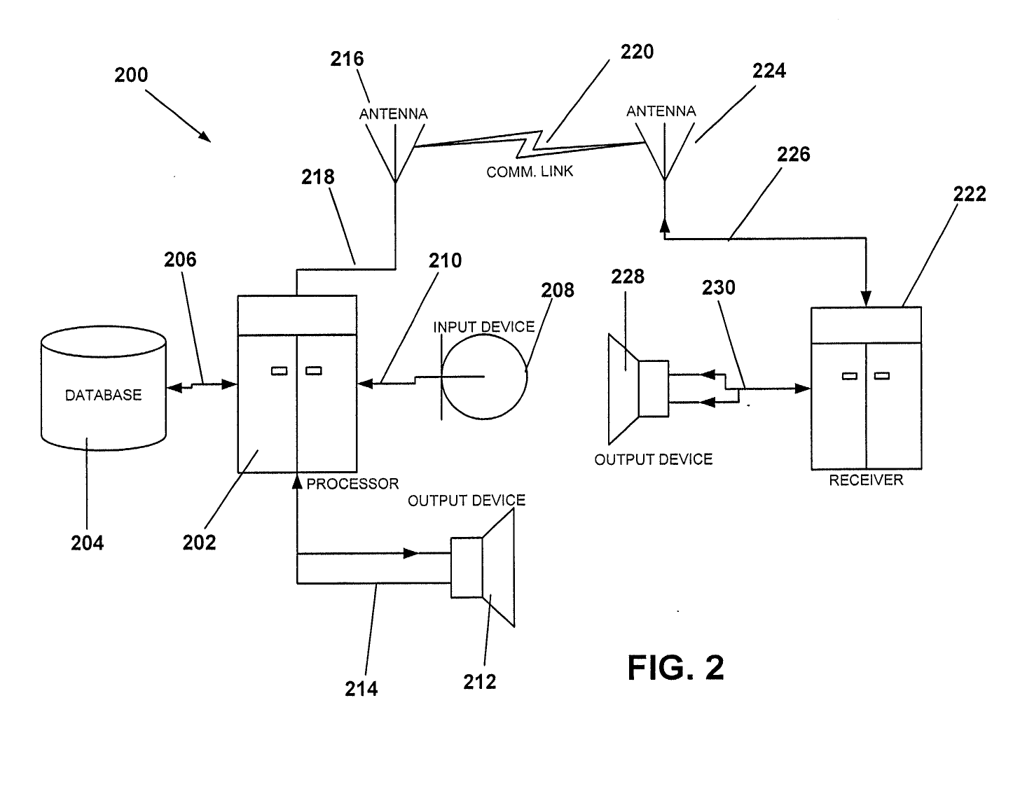

Referring now to FIG. 2, another embodiment 200 of a device for providing instant verbal translations is depicted. As shown, this embodiment utilizes many of the components of the embodiment shown in FIG. 1, however, instead of using two processors (102/122 in FIG. 1), this embodiment utilizes a single processor 202. Further, for this embodiment, a single input device 208 (for example, a microphone) is utilized. Also, a single database 204 and database connection 206 are utilized. While the database is illustrated as a single device, it is to be appreciated that multiple databases may be utilized.

Further, in this embodiment, two output devices (for example, a speaker or a headset) 212/228 are also utilized. Each Person has a unique output device 212/228 by which they receive translated communications, as necessary. Additionally, this embodiment utilizes the communications link 220 to transmit translated communications to a receiver 222 which suitably presents the communications to the second user via the output device 228.

In this embodiment 200, all of the receiving of verbal communications occurs via the single input device 208. The received communications are then translated, as necessary, by the processor 202. The translated communications are then presented to the intended recipient (i.e., either the first user or the second user) via the output device 212 or via the communications link 220, the receiver 222, and the second output device 228. As such, this embodiment 200 eliminates the need for both Persons to have full verbal communications translations capabilities. Instead, all translations are accomplished by a single device and translations are provided to the second device via a remote receiver and headset. It is anticipated that this embodiment 200 could be utilized by providing waiters, conductors and others who come into frequent contact with foreigners with the first device and renting the receiving devices to patrons on an as needed basis.

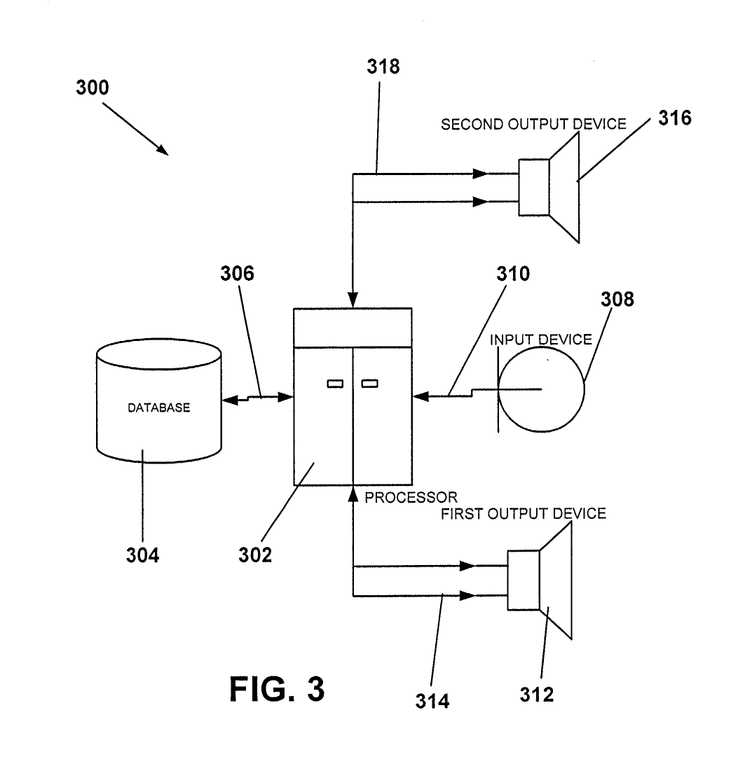

Another embodiment 300 of the present invention is depicted in FIG. 3. In this embodiment, as in the embodiment 200 provided for in FIG. 2, a single processor is utilized. However, instead of utilizing a remote receiver 222 connected to the processor 202 via the communications link 220 (see FIG. 2), this embodiment 300 utilizes two output devices 312/316 which are connected to the processor 302. This embodiment 300 may be configured such that one of the output devices 312 is, for example, an earpiece or headset, by which only the first user hears the communications, while the second output device 316 may be a speaker by which the second user hears the communication.

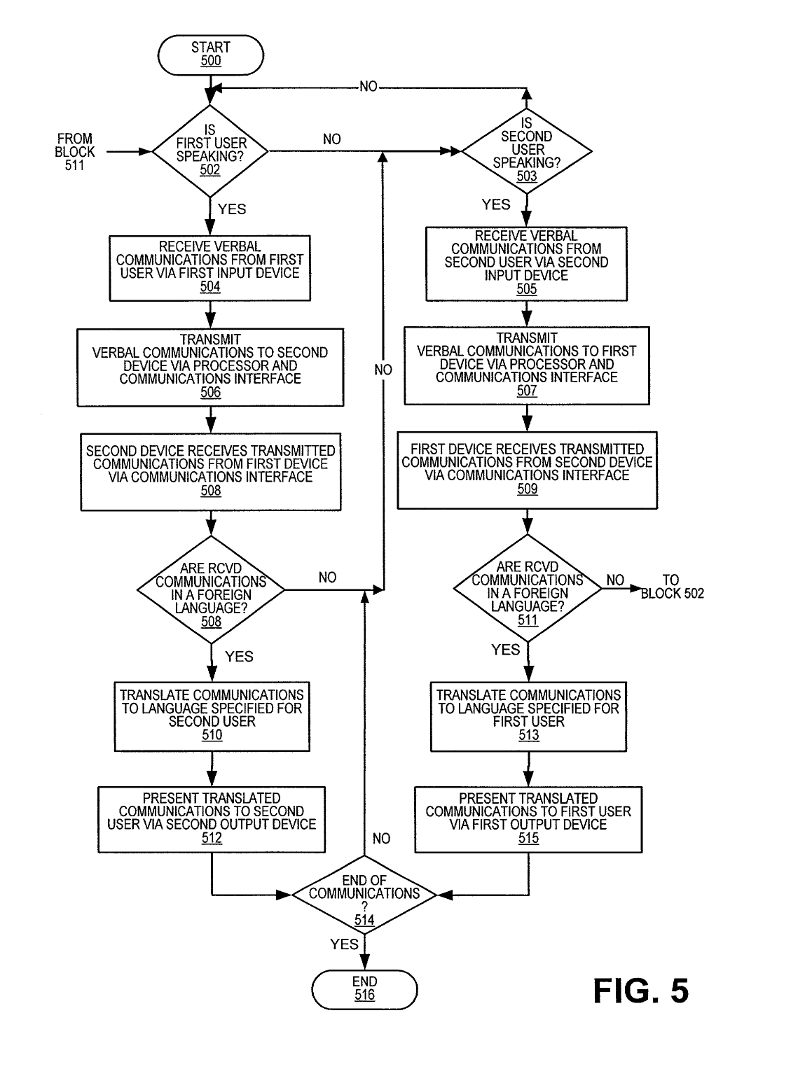

One process by which the embodiments shown in FIGS. 1-3 may be implemented and provide instant verbal translations is illustrated in FIG. 5. As shown, this process begins with both Persons involved in a verbal communication gaining access to a device (Block 500). When the Person is a human being, this step may require the user to receive a device, and insert an earpiece or wear a headset. When the Person is an automated system (for example, an ATM with voice capabilities for the visually impaired), the capabilities of a device may be built-in the system. In any event, the process begins when both Persons have access to instant verbal translating capabilities, with one of the Persons using a device capable of providing instant verbal translations, for example, the device illustrated in FIG. 1.

Once the device(s) is initialized, the process continues with each device determining whether a Person using the device is speaking or otherwise making utterances (Step 502). For purposes of illustration only, a first user is considered to be the Person by whom a specific device is being utilized and a second user is considered to be the Person with whom the first user is communicating. If the first user is speaking, the device proceeds with receiving the verbal communications (Block 504).

If the first user is not speaking, the device determines whether the second user is speaking (Block 503). If the second user is not speaking, the process waits until either the first user and/or the second user is speaking (i.e., the process continues to loop through Blocks 502-504 until a user speaks). Preferably, the device determines if the second user is speaking by determining whether a signal is being received from the second user device via the communications link (120, FIG. 1). It is to be appreciated, however, that in the other embodiments wherein a single or common input device is used to receive the verbal communications from both Persons (for example, the embodiments shown in FIGS. 2 and 3) this step may also be accomplished by determining whether a verbal communication received by the input device is in the first user's specified language or in a second language.

When the first user is speaking the process proceeds through Blocks 504-506-508-510-512. Similarly, when the second user is speaking the process proceeds through Blocks 503-505-507-509-511-513-515. The process flow for either the first user or the second user speaking is practically identical with the exception being whether the received verbal communications are received in a first language (for example, English) and translated into a second language (for example, French) or vice versa.

As shown in Block 504 (or in Block 505 for the second user speaking), the process continues with the device receiving the verbal communications from the first user via a first input device. When a two device configuration is utilized, the processor for the first device then communicates the received communications from the first user device to the second user device (Block 506, or vice versa for Block 507). When a single processor configuration is utilized (for example, see the embodiments in FIGS. 2 and 3), this step is not performed.

Upon receiving the verbal communications, the processor to which the verbal communications was transmitted (Block 508 or Block 509) then determines whether the received communications are in a foreign language (i.e., a language other than that specified for the first user, or the second user). If the communications are not in a foreign language (i.e., no translation is needed), the processing continues with searching for the receipt of the next verbal communications. If the received verbal communications are in a foreign language, the process continues with translating the communications into a language previously specified by the first user (Block 510) or the second user (Block 513), respectively.

The translated communications are then presented to the corresponding first or second user via the second output device (for a verbal communication from the first user) or via the first output device (for a verbal communication from the second user) (Block 512 and 515 respectively). At this point the process then determines whether more communications are to be received and translated (Block 514). When all communications that are to be translated have been completed, the process may reenter a wait state (i.e., Blocks 502-503) or may be ended (Block 516). Thus, the process shown in FIG. 5 provides one embodiment of a process for receiving verbal communications, identifying the language of the received verbal communications, translating the verbal communications and outputting the translated communications to the intended recipient. It is to be appreciated that the process may vary as necessary to accommodate varying languages. For example, when translating German to English, the presentation of a translated sentence may not occur until the entire sentence has been received, identified, and then translated. Further, the process steps may also vary based upon whether a single processor is utilized, whether multiple processors are utilized, and/or whether multiple receptions, identifications, and translations are occurring (i.e., whether more than one language/communication is being translated at any given time). When multiple processors are used, both processors may be accomplishing the translation of verbal communications simultaneously. Similarly, single processor embodiments may be configured to multi-task such that translations for any Person are not substantially delayed.

Therefore, it is to be appreciated that while the present invention has been described herein in the context of four system embodiments and one process embodiment, modifications, additions, and deletions of system components and/or process steps may be accomplished and shall be considered to be within the scope of the present invention, as set forth by the specification, the drawing figures and the claims.

In the claims:

1. A system for instantly translating verbal communications in a first language into at least one second language, wherein the first language is specified by a first Person and a second language is specified by a second Person, comprising:
a first input device, for receiving a first verbal communication communicated in a first language by a first Person;
a second input device, for receiving a second verbal communication communicated in a second language by a second Person;
a first processor, connected to the first input device, for processing and transmitting the first verbal communication and receiving and translating the second verbal communication into a first specified language;
a second processor, connected to the second input device, for processing and transmitting the second verbal communication and receiving and translating the first verbal communication into a second specified language;
a first database, connected to the first processor, providing at least one language translation application utilized by the first processor to translate the second verbal communication into the first specified language;
a second database, connected to the second processor, providing at least one language translation application utilized by the second processor to translate the first verbal communication into the second specified language;
a first output device, connected to the first processor for presenting to the first Person a converted second verbal communication in the first specified language;
a second output device, connected to the second processor, for presenting to the second Person a converted first verbal communication in the second specified language; and
a communications link connecting the first processor and the second processor; whereupon communication of the first verbal communication into the first input device, the first processor processes the first verbal communication and communicates the first verbal communication to the second processor via the communications link, whereupon receipt of the first verbal communication the second processor translates the first verbal communication into the second specified language and presents a result of the translation to the second Person through the second output device, and
whereupon communication of the second verbal communication into the second input device, the second processor processes the second verbal communication and communicate the second verbal communication to the first processor through the communications link, whereupon receipt of the second verbal communication the first processor translates the second verbal communication into the first specified language and presents a result of the translation to the first Person through the first output device.

2. The system of claim 1, wherein at least one of the first audible message and the second audible message is communicated by an automated system to a Person.

3. The system of claim 1, wherein at least one of the first input device and the second input device further comprise a microphone.

4. The system of claim 1, wherein at least one of the first output device and the second output device further comprise at least one output device selected from the group consisting of: a headset, a speaker, a hearing aid, and an earpiece.

5. The system of claim 1, wherein the first database is connected to the first processor via a network server.

6. The system of claim 1, wherein the communications link connecting the first processor and the second processor further comprises a wireless communications link.

7. A system for translating verbal communications, comprising:
a first device further comprising:
a processor;
an input device, connected to the processor;
a first output device, connected to the processor; and
a database, connected to the processor;
a remote device further comprising:
a receiver; and
a second output device connected to the receiver; and
a communications interface connecting the first device with the remote device; whereupon reception by the input device of a first verbal communication by a Person, the processor recognizes a language utilized in the first verbal communication, determines an intended recipient of the first verbal communications, translates the first verbal communications and transmits the first verbal communications to the remote device via the communications interface when the first verbal communication is directed towards a second Person, and outputs the translated first verbal communications via the output device when the first verbal communication is intended for the Person.

8. The system of claim 7, wherein the input device further comprises a microphone.

9. The system of claim 7, wherein at least one of the first output device and the second output device further comprises an output device selected from the group consisting of: a speaker, a headset, a hearing aid, and an earpiece.

10. The system of claim 7, wherein the database is located remotely from the processor and the first device further comprises a second communications interface connecting the processor with the first device.

11. The system of claim 7, wherein the communications interface further comprises a wireless communications link.

12. A system for translating verbal communications, comprising:
a processor;
an input device, connected to the processor, for receiving a verbal communication;
a first output device, connected to the processor, for presenting a verbal communication to a first Person;
a second output device, connected to the processor, for presenting a verbal communication to a second Person; and
a database, connected to the processor; whereupon receiving a verbal communication via the input device, the processor utilizes at least one software program stored in the database to recognize and translate the verbal communication from a first language into a second language, the processor outputs the translated verbal communication to at least one of the first Person and the second Person via an either the first output device or the second output device, respectively, based upon a previously provided specification of a language in which each of the first Person and the second Person respectively desires to receive translated verbal communications.

13. The system of claim 12, wherein the input device further comprises a microphone.

14. The system of claim 12, wherein at least one of the first output device and the second output device further comprises at least one output device selected from the group consisting of: a speaker, a headset, a hearing aid, and an earpiece.

15. The system of claim 12, wherein the at least one of the first output device and the second output device is connected to the processor via a wireless communications link.

16. A process for providing instant translations of verbal communications from one Person to a second Person, comprising:
receiving a verbal communication from a first Person;
recognizing a language utilized in the verbal communication;
determining an desired output language for presenting a translation of the verbal communication to the second Person;
translating the verbal communication into the desired output language; and
presenting the translated verbal communication to the second Person;
wherein the verbal communication is received via a first input device, translated by a processor and output to the second Person via at least one portable device equipped with at least two output devices such that interference is reduced between the verbal communications communicated by the first Person and received by the second Person, and communications communicated by the second Person and received by the first Person.

17. The process of claim 16, wherein the process further comprises establishing a communications link between a first device utilized by the first Person and a second device utilized by the second Person, wherein the first device includes an input device for receiving verbal communications from the first Person and an output device for presenting translated verbal communications from the second Person and the second device includes an input device for receiving verbal communications from the second Person and an output device for presenting translated verbal communications from the first Person; each of the first Person and the second Person receiving the translated verbal communications in a language specified by each Person.

18. The process of claim 17, wherein the communications link between the first device and the second device utilizes a wireless communications link.

19. A computer readable medium containing software utilized to instantly translate verbal communications from a first language to a second language comprising:
recognizing a first language utilized for a verbal communication;
determining a desired output language;
translating the verbal communication from the first language into the desired output language; and
providing the translated verbal communication to at least one device for presentation to at least one Person;
wherein the steps or recognizing, determining, translating and providing are implemented by a processor connected to each of at least one input device, at least one first output device and at least one second output device; the at least one input device being configured to receive a verbal communication from at least one of a first Person and a second Person; the at least one first output device being configured to present translated verbal communication, received from the first Person, to the second Person; the at least one second output device being configured to present translated verbal communications, received from the second Person, to the first Person.

20. The computer readable medium of claim 19, wherein the computer readable medium is hosted on a database connected to the processor via a network server.
